(19) United States
(12) Patent Application Publication
(10) Pub. No.: US 2008/0063140 A1
(43) Pub. Date: Mar. 13, 2008

(54) System and Method for Detecting the Presence of a Threat in a Package

(76) Inventor: William Awad, L'lle Bizard (CA)

Correspondence Address: Louis Tessier, P O Box 54029, Town of Mount-Royal, H3P 3H4, CA

(21) Appl. No.: 11/632,836

(22) PCT Filed: Jul. 20, 2005
(86) PCT No.: PCT/CA05/01143

§ 371 Date: Sep. 27, 2007

Related U.S. Application Data
(60) Provisional application No. 60/588,999, filed on Jul. 20, 2004.

(51) Int. Cl. G01N 23/04

(52) U.S. Cl. 378/57

(57) ABSTRACT

A method for scanning an object for potential threats. The method includes steps obtaining a plurality of stereographic colored X-ray images of the object, combining the plurality of stereographic images to produce a tridimensional model of the object, classifying each voxel from the tridimensional model into a predetermined material class indicative of a type of material included at a physical location modeled by the voxel, segmenting the tridimensional model using the intensity values and material classes associated with the voxels, thereby producing a segmented model including a plurality of object sub-components classifying each of the object sub-components included in the segmented model into a threat class, and issuing an alert signal upon a detection of an object subcomponent classified into a threatening class.

This application claims priority from U.S. Provisional Patent Applications Ser. No. 60/588,999 filed Jul. 20, 2004.

### FIELD OF THE INVENTION

The present invention relates to the general field of remote sensing. More specifically, the present invention is concerned with a system and a method for detecting the presence of a threat in a package.

### BACKGROUND OF THE INVENTION

Security systems for X-ray scanning of objects are used at many locations, for example in airports. Typically, an object, such as for example a package or a piece of luggage, is scanned by X-rays to produce and image that is thereafter displayed on a monitor. Then, a user attempts to visually determine whether or not a threat is present within the object. For example, the user looks for the presence in the image of a shape similar to the shape of a gun or of a knife, among others.

The efficiency of such systems depends on the proficiency and awareness of the user. However, users of currently used systems are often rather novice at this task and may therefore fail to detect many potential threats. In addition, it is often the case that very few threats are effectively present in the scanned objects, which may lead to lack of attention from the user who has to look at images of non-threatening objects for many consecutive hours.

In addition, it may be relatively hard for the user to identify combinations of unassembled or harmless substances contained into the object that may represent a danger in the event that they could be assembled or mixed together.

Compounding all these problems, currently used X-ray systems typically do not allow to identify the chemical composition of items within the object. Therefore, dangerous chemicals, such as for examples explosives or biological agents, contained within a container located within the object are often not detected using X-ray systems.

Against this background, there exists a need in the industry to provide novel systems and methods for detecting the presence of an object in a package.

### OBJECTS OF THE INVENTION

An object of the present invention is therefore to provide a novel system and method for detecting the presence of an object in a package.

### SUMMARY OF THE INVENTION

In a first broad aspect, the invention provides a method for detecting the presence of a threatening object in a package. The method includes obtaining a multi-energy X-ray image of the package, the multi-energy X-ray image being obtained using X-rays having at least two substantially distinct image energies. A region of interest is selected within the multi-energy X-ray image and a region of interest signature is computed, the region of interest signature being indicative of the absorption of X-rays within the region of interest at all image energies. The satisfaction of a specific threat detection criterion is determined for the region of interest signature. A predetermined action is taken upon the specific threat detection criterion being satisfied.

In some embodiments of the invention, the multi-energy X-ray image is an X-ray image obtained using two substantially distinct image energies. However, in alternative embodiments of the invention, the multi-energy X-ray image may is obtained using three, four or more distinct image energies.

The region of interest is a region of the multi-energy X-ray image over which a signature is computed. The region of interest may, for example, correspond to an object in the package. However, this is not necessarily the case in all embodiments of the invention and, for example, the region of interest may also contain more than one object or only part of an object.

The region of interest signature combines information related to the absorption of X-rays within the region of interest at all image energies. In some embodiments of the invention, the region of interest signature is simply a vector containing the absorption coefficient of the X-rays at each image energy within the region of interest. In other embodiments of the invention, the region of interest signature is obtained by computing from these absorption coefficients a density and an effective atomic number.

In yet other embodiments of the invention, the information related to the absorption of X-rays is encoded in a single number or string of characters. In these embodiments of the invention, it may be simpler to detect whether a specific threat detection criterion is satisfied or not. Also, such an encoding allows the production of proprietary databases including predetermined threat signatures. Advantageously, the method allows the identification of a substance included in the package. Also, in some embodiments of the invention, determining if the specific threat detection criterion is satisfied it is relatively easy and relatively fast to perform. This allows scanning packages for threat at relatively large throughputs.

In some embodiments of the invention, the method is performed entirely automatically by a computer so as to reduce the need to have relatively specialized security personnel performing a relatively monotonous task.

In some embodiments of the invention, the method includes selecting another region of interest within the multi-energy X-ray image, computing another region of interest signature and determining if another specific threat detection criterion is satisfied by the other region of interest signature. Another predetermined action is taken upon the specific threat detection criterion and the other specific threat detection criterion being both satisfied.

For example, if first and second substances that are relatively safe when taken in isolation are relatively easy to combine to form a third substance posing a threat, in these embodiments, the invention allows to detect the presence of a threat caused by the first and the second substances being both present within a package.

Also, in some embodiments of the invention, a similar method is performed for regions of interest present in two separate packages that are, for example, scheduled to be transported in a common shipment.

In another broad aspect, the invention provides a threat detection system for detecting the presence of a threatening object in a package.

In yet another broad aspect, the invention provides a machine readable storage medium containing a program element for execution by a computing device, the program element being provided for detecting the presence of a threatening object in a package.

In yet another broad aspect, the invention provides a method for remotely detecting the presence of a substance.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a block diagram view, illustrates a threat detection system in accordance with an embodiment of the present invention;

FIG. 2, in a schematic view, illustrates an image acquisition system of the threat detection system of FIG. 1;

FIG. 3, in a schematic view, illustrates an image of a package acquired using the image acquisition system of FIG. 2;

FIG. 4, in a flow chart, illustrates a method for detecting the presence of a threatening object in a package that is performable by the threat detection system of FIG. 1;

FIG. 5, in a schematic view, illustrates a database of predetermined threat signatures used in some embodiments of the invention by the method of FIG. 4; and

FIG. 6, in a block diagram view, illustrates a program element for detecting the presence of a threatening object in a package.

### DETAILED DESCRIPTION

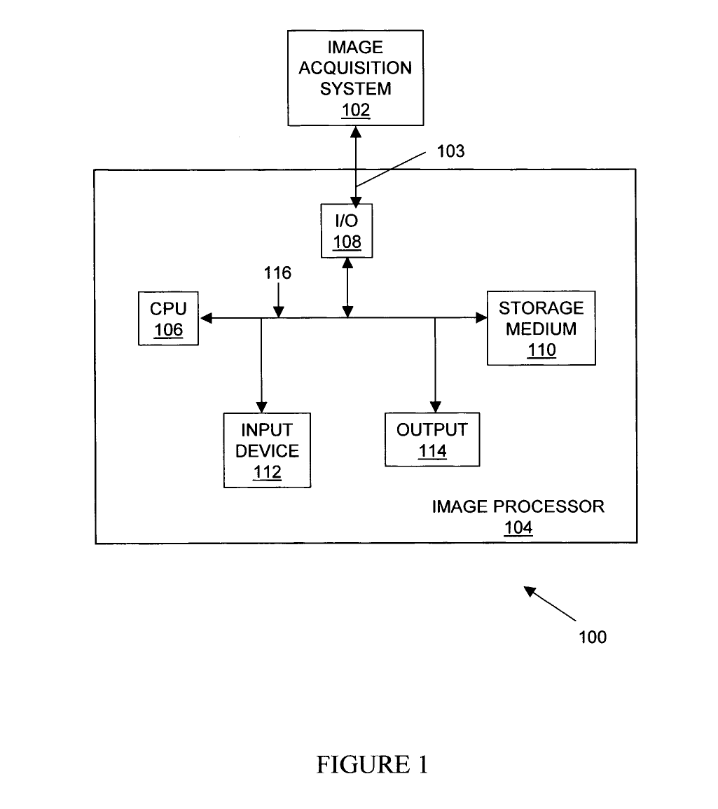

FIG. 1, in a schematic view, illustrates a threat detection system 100. The threat detection system 100 includes an image acquisition system 102 and an image processor 104 linked to the image acquisition system 102 by a communication link 103. The communication link 103 is any suitable communication link, such as for example and non-limitatively, a bus, an electrical serial link, an electrical parallel link, an optical fiber, a network, an infrared link or a radio link, among others.

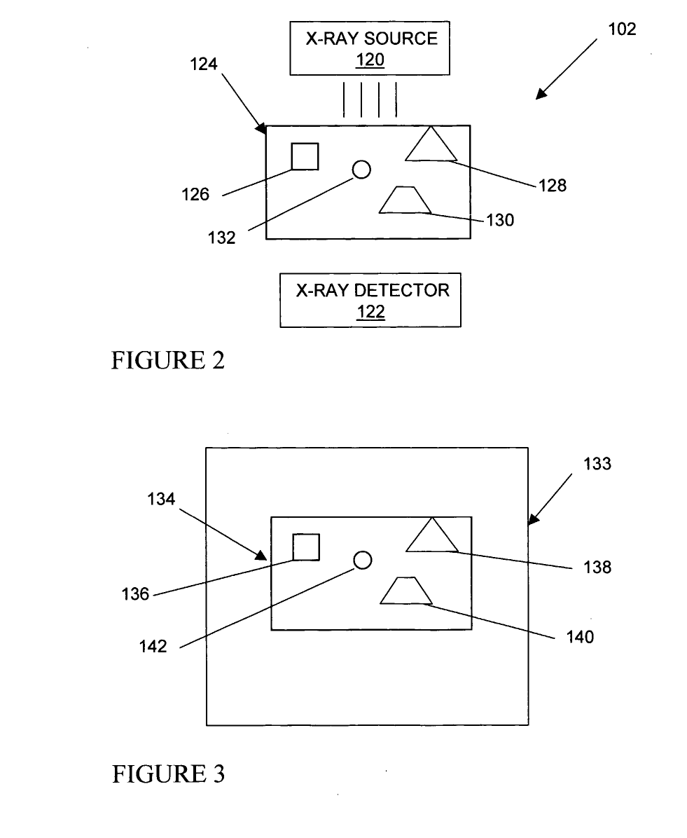

The threat detection system 100 allows detecting the presence of a threatening object in a package 124 (shown in FIG. 2). Although the image acquisition system 102 and the image processor 104 are shown separately in FIG. 1, the reader skilled in the art will readily appreciate that these two components of the threat detection system 100 are either provided in separate devices or included within a single device in specific embodiments of the invention.

As shown schematically in FIG. 2, the image acquisition system 102 includes an X-ray source 120 and an X-ray detector 122. The package 124 is insertable between the X-ray source 120 and the X-ray detector 122. The package 124 includes objects 126, 128, 130 and 132. The reader skilled in the art will readily appreciate that although the package 124, the X-ray source 120 and the X-ray detector 122 are represented in two dimensions in FIG. 2, it is within the scope of the invention to have image acquisition system 102 that operate in three dimensions.

Also, although the image acquisition system 102 shown in the drawings includes only one X-ray source 120 and one X-ray detector 122, it is within the scope of the invention to use two or more X-ray sources 120 and two or more X-ray detectors 122 in the image acquisition system 102.

The X-ray source 120 is capable of emitting X-rays having at least two substantially distinct image energies, thereby allowing the acquisition of a multi-energy X-ray image.

Also, the multi-energy X-ray image may be an unidimensional, a bidimensional or a tridimensional multi-energy X-ray image. In a specific example of implementation, the multi-energy X-ray image is acquired using a computed tomography system.

In some embodiments of the invention, the image energies are substantially monochromatic. In alternative embodiments of the invention, the image energies each present a respective spectrum of X-ray energies. In this latter case, it is within the scope of the invention to use image energies having spectrum that either overlap or do not overlap. The use of two X-ray energies or more allows the absorption of X-rays by the package 124 to be characterized at each image energy, which in turn allows remotely determining the chemical composition of the package 124 and of the objects 126, 128, 130 and 132. This, in turn, allows detecting the presence of specific substances in the objects 126, 128, 130 and 132. For example, detecting the presence of specific substances in the objects 126, 128, 130 and 132 is performed by matching the parameters derived from the multi-energy X-ray image with known data, as described in further details hereinbelow.

The X-ray detector 122 detects the X-rays emitted by the X-ray source 120 further to their passage through the package 124. The X-ray detector 122 allows the formation of a multi-energy X-ray image 133 (shown in FIG. 3).

Referring to FIG. 3, in the multi-energy X-ray image 133, there are regions generally corresponding to the package 124 and to the objects 126, 128, 130 and 132. More specifically, a package region 134 generally corresponds to the package 124 and object regions 136, 138, 140 and 142 generally correspond to the objects 126, 128, 130 and 132. The multi-energy X-ray image 133 in FIG. 3 is represented in two dimensions for illustrative purposes only, and in some embodiments of the invention the multi-energy X-ray image 133 is a three-dimensional image.

Image acquisition systems are well-known in the art and the image acquisition system 102 will therefore not be described in further details.

As a non-limiting example, the package 124 is illustrated containing four objects 126, 128, 130 and 132. In this example, the object 126 is a threatening object. An example of a threatening object is a lump of an explosive material.

Threatening objects are objects posing a threat. For example, threatening objects may have the potential of causing damages to structures or to harm living beings. Alternatively, threatening objects include substances that are either illegal or for which the circulation thereof is restricted. While some examples of threatening objects have been mentioned hereinabove, the scope of the invention as claimed should not be limited by these examples. Accordingly, the threatening object may be any other suitable threatening object.

The objects 128 and 130, taken in isolation, are not threatening objects per se. However, the object 128 and the object 130 are combinable to form a threatening object. For example, and non-limitatively, the objects 128 and 130 may be containers including first and second explosive precursors, that, when combined, form an explosive. Therefore, the objects 128 and 130 are referred to hereinbelow as partially threatening objects 128 and 130.

Finally, the object 132 is a safe object that does not represent a threat.

The shapes of the objects 126, 128, 130 and 132 are only for illustrative purposes and serve to distinguish these objects from each other. The reader skilled in the art will readily appreciate that in real-world packages, objects do not necessarily have these shapes.

Referring to FIG. 1, in some embodiments of the invention, the image processor 104 takes the form of a general purpose computer including a Central Processing Unit (CPU) 106 connected to a storage medium 110 over a data bus 116. Although the storage medium 110 is shown as a single block, it may include one or more separate components, such as a floppy disk drive, a fixed disk, a tape drive and a Random Access Memory (RAM), among others.

The image processor 104 also includes an Input/Output (I/O) interface 108 that connects to the data bus 116. The image processor 104 communicates with outside entities through the I/O interface 108. In a non-limiting example of implementation, the I/O interface 108 is a network interface. In a further non-limiting example of implementation, the I/O interface includes a port for exchanging electrical signals with the image acquisition system 102 through the communication link 103. The electrical signals conveyed from the image acquisition system 102 are representative of the multi-energy X-ray image 133 acquired by the image acquisition system 102.

The image processor 104 further includes an output device 114 to communicate information to an intended user. In the example shown, the output device 114 includes a monitor (not shown in the drawings) for displaying the multi-energy X-ray image 133. In other embodiments of the invention, the output device 114 includes a printer or a loudspeaker.

The image processor 104 also includes an input device 112 through which the user may input data or control the operation of a program element executed by the CPU 106. The input device 112 may include, for example, any one or a combination of the following: keyboard, pointing device, touch sensitive surface or speech recognition unit.

The reader skilled in the art will readily appreciate that the image processor 104 is replaceable by any other suitable image processor without departing from the scope of the invention. For example, alternative image processors are implemented using any other components, such as for example dedicated digital circuitry or analog image processing circuitry.

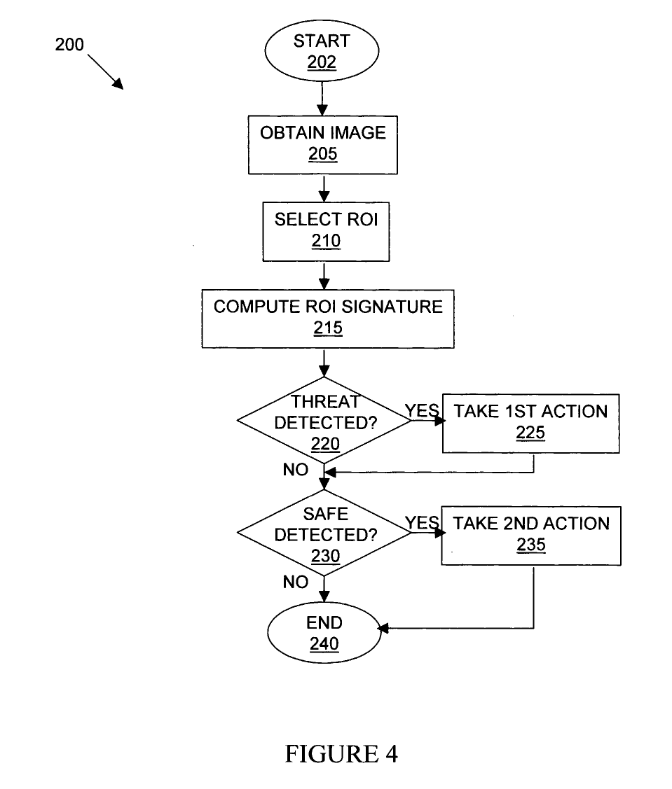

FIG. 4 illustrates a method for detecting the presence of a threatening object in the package 124 performed by the threat detection system 100. The method 200 starts at step 202. Then, at step 205, a multi-energy X-ray image 133 of the package 124 is obtained. The multi-energy X-ray image 133 is obtained using X-rays having at least two substantially distinct image energies. To remove any ambiguity, for the purpose of this specification, the term “image energy” refers to the energies at which the multi-energy X-ray image 133 is obtained.

Then, at step 210, a region interest is selected within the multi-energy X-ray image 133 by the image processor 104. In some embodiments of the invention, but not necessarily, more than one region interest is selected within the multi-energy X-ray image 133 by the image processor 104. For example, in some embodiments of the invention, the region of interest generally corresponds to one of the objects 126, 128, 130 and 132. In these cases, the region of interest is substantially identical with one of the object regions 136, 138, 140 and 142. The selection of regions of interest is further detailed hereinbelow.

Then, at step 215, a region of interest signature is computed for each region of interest selected at step 210. The region of interest signatures are indicative of the absorption of X-rays within each region of interest at all image energies.

At step 220, the satisfaction of a specific threat detection criterion for each region of interest signature is performed. For each region of interest, if the specific threat detection criterion is satisfied, a first predetermined action is taken at step 225 and the method jumps to step 230. Otherwise, if the specific threat detection criterion is not satisfied, the method jumps to step 230.

At step 230, the satisfaction of a specific safety detection criterion by each region of interest signature is determined. If the safety detection criterion is satisfied, at step 235, a second predetermined action is taken and the method ends at step 240. Otherwise, if the specific safety detection criterion is not satisfied, the method ends directly at step 240.

In alternative embodiments of the invention, step 230 and step 235 are not present and the method directly jumps from either of steps 220 and 225 to step 240 at which the method ends.

Also, in some embodiments of the invention, steps 215 to 235 are performed for each region of interest selected at step 210.

The acquisition of the multi-energy X-ray image has been briefly described hereinabove and is performable using any suitable image acquisition system 102 using any of the image acquisition methods that are well known in the art. Accordingly, the step of obtaining images 205 is not described in further details hereinbelow.

At step 210, the region of interest is selected using any suitable method. In some embodiments of the invention, the region of interest is selected manually by a user. In other embodiments of the invention, the region of interest is automatically selected by the image processor 104.

In some embodiments of the invention wherein the region of interest is automatically selected, the multi-energy X-ray image 133 is first segmented to obtain segmented regions of substantially uniform regions signature indicative of the absorption of X-rays at all image energies. For example, in some embodiments of the invention, the segmented regions generally correspond to the package and object regions 134, 136, 138, 140 and 142. Then, regions of interest are selected as corresponding to the segmented regions. Methods for segmenting images and for selecting regions of interest are well known in the art and will therefore not be described in further details hereinbelow.

The region of interest signature combines information related to the absorption of X-rays within the region of interest at all image energies. Computing the region of interest signatures at step 215 may be performed in many manners.

For example, in some embodiments of the invention, the region of interest signature is simply a vector containing the absorption coefficient of the X-rays at each image energy within the region of interest. The absorption coefficient is a coefficient by which a distance traveled by X-rays through a material is multiplied in a decaying exponential transmission law.

In other embodiments of the invention, the region of interest signature is obtained by computing from the absorption coefficients a density and an effective atomic number. Methods for obtaining densities and effective atomic numbers are well-known in the art and will therefore not be described in further details.

In yet other embodiments of the invention, the information related to the absorption of X-rays is encoded in a single number or string of characters. In these embodiments of the invention, it may be simpler to detect whether a specific threat detection criterion is satisfied or not. Also, such an encoding allows the production of proprietary databases including predetermined threat signatures since the encoding method is typically kept secret.

In some embodiments of the invention, the region of interest signature is indicative of an average absorption of X-rays within the region of interest at all image energies. However, in other embodiments of the invention, the region of interest signatures is computed in any other suitable manner.

For example, in some embodiments of the invention, the region of interest signature is further indicative of a standard deviation of the absorption of X-rays within the region of interest of all image energies

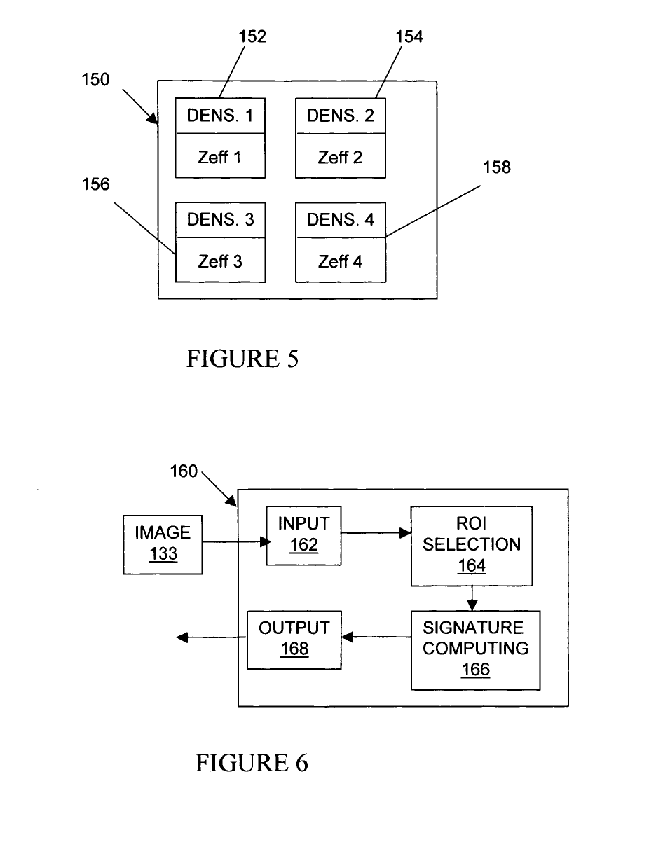

In other embodiments of the invention, a determination of the satisfaction of a specific threat detection criterion is performed at step 220 by identifying a specific threat signature within a database of predetermined threat signatures that matches the region of interest signature. In these embodiments of the invention, the storage media 110 contains a database of predetermined threat signatures 150 shown in FIG. 5.

The database of predetermined threat signatures 150 includes first, second and third predetermined threat signatures 152, 154 and 156. Each of the predetermined threat signatures 152, 154 and 156 includes a number representative of a density and a number representative of an effective atomic number. The database of predetermined threat signatures 150 shown in FIG. 5 is only given for illustrative purposes and databases of threat signatures may include more or less than the three threat signatures that are shown in FIG. 5. Also, it is within the scope of the invention to have databases of predetermined threat signatures including signatures that differ from the specific example of threat signatures given in this example.

The predetermined threat signatures 152, 154 and 156 are indicative of the absorption of X-rays by a threat at all image energies. Also, in some embodiments of the invention, the database of predetermined threat signatures 150 includes a predetermined safe signature 158, the predetermined safe signature being indicative of the absorption of X-rays by a safe material at all image energies.

For the purpose of this example, the first threat signature 152 is the signature of a material that, by itself, poses a threat such as, for example, an explosive. Also, the second and third threat signatures 154, and 156 are each indicative of the absorption of X-rays by materials which, by themselves, do not pose a threat but that, if combined, may form a third material that causes a threat. Such threat signatures are referred to hereinbelow as partial threat signatures 154 and 156

A specific threat signature matches a region of interest signature upon the absorption of X-rays in the region of interest being substantially equivalent to the absorption of X-rays for all image energies represented by the specific threat signature. This may be the case when, for example, the density and the effective atomic number of one of the regions of interest, say, for example, the object region 136, is substantially equal to the density and effective atomic number contained in one of the predetermined threat signature say, for example, the first threat signature 152.

Upon the threat detection criterion being satisfied, a first predetermined action is taken at step 225. Examples of predetermined action include issuing an alert, stopping a package handling system, or taking any other suitable action. The specific predetermined action taken depends upon the context into which the threat detection system 100 is used and will readily be determined by the person skilled in the art.

In a specific case wherein the signature of the region of interest matches one of the partial threat signature 154 and 156, step 220 further includes determining if the other partial threat signature 154 and 156 within the database of predetermined threat signatures 150 has already been matched by another region of interest and if a region of interest combination criterion is satisfied.

The region of interest combination criterion is a criterion that is satisfied if the detection of the partial threat signature 154 and 156 poses a threat. In other words, the region of interest combination criterion indicates that the combined satisfaction of the specific threat detection criterion and the other specific threat detection criterion poses a threat.

First, the region of interest combination criterion includes having two partial threat signatures that are indicative of substances that may be indeed combined together to form a threat, as not all combinations of partial threats have a potential to form a threat. For example, a first and a second substances may be combinable to form a threat and a third and a fourth substances may be combinable to form another threat, but a combination of the first and third substances may be safe.

Also, the region of interest combination criterion includes having two partial threat signatures 154 and 156 that have been observed so that it is likely that the two partial threats may be combined. For example, and non-limitatively, the region of interest combination criterion includes identifying the two partial threat signatures 154 and 156 for regions of interest contained within a same package 124 or from a single multi-energy x-ray image 133. In another examples, the region of interest combination criterion includes having obtained two multi-energy x-ray images 133 from which respectively the two partial threat signatures 154 and 156 have been matched within a predetermined time interval. In yet another example, the region of interest combination criterion includes having obtained two multi-energy x-ray images 133 from which the two partial threat signatures 154 and 156 have been respectively matched from two packages 124 scheduled for transportation in a common shipment.

If the region of interest combination criterion is not satisfied, then there is no detection of a threat and the method 200 jumps to step 230.

In some embodiments of the invention, but not necessarily in all embodiments of the invention, the region of interest is identified as containing a safe item upon the region of interest signature satisfying a specific safety detection criterion. For example satisfying the specific safety detection criterion includes identifying a specific safe signature 158 within the database of predetermined threat signatures 150 that matches the region of interest signature. The specific safe signature matches the region of interest signature upon the absorption of x-rays in the region of interest being substantially equivalent to the absorption of x-rays indicated by the specific safe signature for all image energies.

If only safe objects have been detected within a package, a second predetermined action is taken at step 235. For example, the second predetermined action may include issuing a clearance signal indicating that the package is safe, or moving the package at another location, among other possibilities.

In alternative embodiments of the invention, the method 200 also includes obtaining at step 205 a complementary image of the package. A non-limiting example of a complementary image is an ultrasound image. In these embodiments of the invention, the region of interest signature is further indicative of a parameter of the complementary image for the region of interest. The addition of image acquisition modalities helps to improve the ability of the threat detection system 100 to discriminate safe substances and objects from threatening substances and objects.

In yet other embodiments of the invention, region of interest signatures further include a geometric parameter indicative of the geometry of the region of interest, the region of interest signature being thereby indicative of the geometry of the region of interest. Once more, having a capacity to identify objects by geometry in addition to by chemical composition further improves the ability of the threat detection system 100 to discriminate safe substances and objects from threatening substances and objects.

In some embodiments of the invention, the CPU 106 executes a program element 160, shown in FIG. 6, for detecting the presence of a threatening object in a package 124, the program element 160 being contained in the storage medium 110. The program element 160 includes:

an input module 162 provide for receiving the multi-energy X-ray image 133;

a region of interest selection module 164 provided for selecting a region of interest within the multi-energy X-ray image 133;

a signature computing module 166 provided for computing a region of interest signature, the region of interest signature being indicative of the absorption of X-rays within the region of interest at all image energies; and

an output module 168 provided for:

determining if the region of interest signature satisfies a specific threat detection criterion; and

issuing predetermined threat signal upon the specific threat detection criterion being satisfied.

The predetermined threat signal indicates that a threatening object has been detected within the package 124. The predetermined threat signal is either issued to an intended user or issued to another program element for further processing.

In other embodiments of the invention, a similar system and method is used to detect the presence of any object or substance in a package or any other object.

Although the present invention has been described hereinabove by way of preferred embodiments thereof, it can be modified, without departing from the spirit and nature of the subject invention as defined in the appended claims.

What is claimed is:

1. A method for detecting the presence of a threatening object in a package, said method comprising:
obtaining a multi-energy x-ray image of the package, the multi-energy x-ray image being obtained using x-rays having at least two substantially distinct image energies;
selecting a region of interest within the multi-energy x-ray image;
computing a region of interest signature, the region of interest signature being indicative of the absorption of x-rays within the region of interest at all image energies;
determining if the region of interest signature satisfies a specific threat detection criterion; and
taking a predetermined action upon the specific threat detection criterion being satisfied.

2. A method as defined in claim 1, further comprising obtaining a database of predetermined threat signatures, each predetermined threat signature being indicative of the absorption of x-rays by a threat at all image energies, wherein satisfying the specific threat detection criterion includes identifying a specific threat signature within the database of predetermined threat signatures that matches the region of interest signature.

3. A method as defined in claim 2, wherein the specific threat signature matches the region of interest signature upon the absorption of x-rays in the region of interest being substantially equivalent to the absorption of x-rays indicated by the specific threat signature for all image energies.

4. A method as defined in claim 2, wherein the region of interest is identified as containing a safe item upon the region of interest signature satisfying a specific safety detection criterion.

5. A method as defined in claim 4, wherein:
the database of predetermined threat signatures further includes at least one predetermined safe signature, each predetermined safe signature being indicative of the absorption of x-rays by a safe material at all image energies; and
satisfying the specific safety detection criterion includes identifying a specific safe signature within the database of predetermined threat signatures that matches the region of interest signature.

6. A method as defined in claim 5, wherein the specific safe signature matches the region of interest signature upon the absorption of x-rays in the region of interest being substantially equivalent to the absorption of x-rays indicated by the specific safe signature for all image energies.

7. A method as defined in claim 1, wherein the region of interest signature is indicative of an absorption of x-rays averaged over the region of interest at all image energies.

8. A method as defined in claim 7, wherein computing the region of interest signature includes computing an average density of the region of interest and computing an average effective atomic number of the region of interest.

9. A method as defined in claim 1, wherein computing the region of interest signature further includes computing a geometric parameter indicative of the geometry of the region of interest, the region of interest signature being thereby indicative of the geometry of the region of interest.

10. A method as defined in claim 1, wherein the region of interest is automatically selected by:
segmenting the multi-energy x-ray image to obtain segmented regions of substantially uniform region signature indicative of the absorption of x-rays at all image energies;
selecting as a region of interest at least one of the segmented regions.

11. A method as defined in claim 1, further comprising obtaining a complementary image of the package, wherein the region of interest signature is further indicative of a parameter of the complementary image for the region of interest.

12. A method as defined in claim 1, further comprising:
selecting another region of interest within the multi-energy x-ray image;
computing another region of interest signature, the other region of interest signature being indicative of the absorption of x-rays within the other region of interest at all image energies;
determining if the other region of interest signature satisfies another specific threat detection criterion; and
taking another predetermined action upon the specific threat detection criterion and the other specific threat detection criterion being both satisfied.

13. A method as defined in claim 1, further comprising:
obtaining another multi-energy x-ray image of another package;
selecting another region of interest within the other multi-energy x-ray image;
computing another region of interest signature, the other region of interest signature being indicative of the absorption of x-rays within the other region of interest at all image energies;
determining if the other region of interest signature satisfies another specific threat detection criterion;
determining if the two regions of interest satisfy a region of interest combination criterion, the region of interest combination criterion indicating that the combined satisfaction of the specific threat detection criterion and the other specific threat detection criterion poses a threat; and
taking another predetermined action upon:
the specific threat detection criterion and the other specific threat detection criterion being both satisfied; and
the two region of interests satisfying the region of interest combination criterion.

14. A method as defined in claim 13, wherein the region of interest combination criterion includes having obtained the two multi-energy x-ray images within a predetermined time interval.

15. A method as defined in claim 13, wherein the region of interest combination criterion includes having obtained the two multi-energy x-ray images obtained from two packages scheduled for transportation in a common shipment.

16. A method as defined in claim 1, wherein the multi-energy x-ray image is a tridimensional image.

17. A threat detection system for detecting the presence of a threatening object in a package, said threat detection system comprising:
an image acquisition system for obtaining a multi-energy x-ray image of the package, the multi-energy x-ray image being obtained using x-rays having at least two substantially distinct image energies;
an image processor for processing the multi-energy x-ray image, said image processor being linked to said image acquisition system, said image processor being operative for:
selecting a region of interest within the multi-energy x-ray image;
computing a region of interest signature, the region of interest signature being indicative of the absorption of x-rays within the region of interest at all image energies;
determining if the region of interest signature satisfies a specific threat detection criterion; and
taking a predetermined action upon the specific threat detection criterion being satisfied; and
a communication link for linking said image acquisition system to said image processor.

18. A threat detection system as defined in claim 17, wherein said image processor includes a database of predetermined threat signatures, each predetermined threat signature being indicative of the absorption of x-rays by a threat at all image energies, wherein satisfying the specific threat detection criterion includes identifying a specific threat signature within said database of predetermined threat signatures that matches the region of interest signature.

19. A threat detection system as defined in claim 17, wherein the region of interest signature is indicative of an absorption of x-rays averaged over the region of interest at all image energies.

20. A threat detection system as defined in claim 17, wherein computing the region of interest signature further includes computing a geometric parameter indicative of the geometry of the region of interest, the region of interest signature being thereby indicative of the geometry of the region of interest.

21. A threat detection system as defined in claim 17, wherein:
said image acquisition system is operative for obtaining a complementary image of the package; and
the region of interest signature is further indicative of a parameter of the complementary image for the region of interest.

22. A threat detection system as defined in claim 17, wherein said image processor is operative for:
selecting another region of interest within the multi-energy x-ray image;
computing another region of interest signature, the other region of interest signature being indicative of the absorption of x-rays within the other region of interest at all image energies;
determining if the other region of interest signature satisfies another specific threat detection criterion; and
taking another predetermined action upon the specific threat detection criterion and the other specific threat detection criterion being both satisfied.

23. A threat detection system as defined in claim 17, wherein:
wherein said image acquisition system is further operative for obtaining another multi-energy x-ray image of another package; and
said image processor is operative for
selecting another region of interest within the other multi-energy x-ray image;
computing another region of interest signature, the other region of interest signature being indicative of the absorption of x-rays within the other region of interest at all image energies;
determining if the other region of interest signature satisfies another specific threat detection criterion;
determining if the two region of interests satisfy a region of interest combination criterion, the region of interest combination criterion indicating that the combined satisfaction of the specific threat detection criterion and the other specific threat detection criterion poses a threat; and
taking another predetermined action upon:
the specific threat detection criterion and the other specific threat detection criterion being both satisfied; and
the two region of interests satisfying the region of interest combination criterion.

24. A threat detection system as defined in claim 17, wherein the region of interest combination criterion includes having obtained the two multi-energy x-ray images within a predetermined time interval.

25. A threat detection system as defined in claim 17, wherein the region of interest combination criterion includes having obtained the two multi-energy x-ray images obtained from two packages scheduled for transportation in a common shipment.

26. A machine readable storage medium containing a program element for execution by a computing device, said program element being provided for detecting the presence of a threatening object in a package using a multi-energy x-ray image of the package, the multi-energy x-ray image being obtained using x-rays having at least two substantially distinct image energies, said program element comprising:
an input module provide for receiving the multi-energy x-ray image,
a region of interest selection module provided for selecting a region of interest within the multi-energy x-ray image;
a signature computing module provided for computing a region of interest signature, the region of interest signature being indicative of the absorption of x-rays within the region of interest at all image energies; and
an output module provided for:
determining if the region of interest signature satisfies a specific threat detection criterion; and
issuing a predetermined threat signal upon the specific threat detection criterion being satisfied.

27. A method for remotely detecting the presence of a substance in an object, said method comprising:
obtaining a multi-energy x-ray image of the object, the multi-energy x-ray image being obtained using x-rays having at least two substantially distinct image energies;
selecting a region of interest within the multi-energy x-ray image;
computing a region of interest signature, the region of interest signature being indicative of the absorption of x-rays within the region of interest at all image energies;
determining if the region of interest signature satisfies a specific detection criterion, the satisfaction of the specific detection criterion indicating the presence of the substance in the package; and
taking a predetermined action upon the specific detection criterion being satisfied.
